(19) United States
(12) Patent Application Publication
(10) Pub. No.: US 2010/0035683 A1
(43) Pub. Date: Feb. 11, 2010

(54) GAMING SYSTEM AND METHOD

(76) Inventor: James H. Cannell, Las Vegas, NV (US)

Correspondence Address: MCANDREWS HELD & MALLOY, LTD, 500 WEST MADISON STREET, SUITE 3400, CHICAGO, IL, 60661, US

(21) Appl. No.: 12/535,047

(22) Filed: Aug. 4, 2009

Related U.S. Application Data
(60) Provisional application No. 61/086,312, filed on Aug. 5, 2008.

(51) Int. Cl. A63F 13/00

(52) U.S. Cl. 463/30; 463/35

(57) ABSTRACT

A gaming system including a player interface, a game controller, and a sound controller. The player interface includes an input mechanism for entering game play instructions, a display for displaying game outcome information and an audio output. The game controller generates game outcomes for a player based on a random result in response to game play instructions and determines any awards to be made to the player for the game outcomes. The sound controller selects at least one sound from a set of a plurality of different sounds for reproduction by the audio output in response to a request to pay out an award to the player.

### RELATED APPLICATIONS

This application claims priority to U.S. Provisional Patent Application No. 61/086,312 having a filing date of Aug. 5, 2008, which is incorporated herein by reference in its entirety.

### FEDERALLY SPONSORED RESEARCH OR DEVELOPMENT

[Not Applicable]

### MICROFICHE/COPYRIGHT REFERENCE

[Not Applicable]

### BACKGROUND OF THE INVENTION

The present invention relates to gaming systems and game methods therefore.

Gaming systems and stand alone game machines are known. Some known game machines enable players to wager on games using tickets, tokens, cards linked to stored credit and other alternatives to having cash circulating on a gaming venue floor.

While such gaming systems provide users with enjoyment, a need exists for alternative gaming systems in order to maintain or increase player enjoyment.

### BRIEF SUMMARY OF THE INVENTION

According to one aspect there is provided a gaming system comprising:
a player interface including an input mechanism for entering game play instructions, a display for displaying game outcome information and an audio output;
a game controller adapted to generate game outcomes for a player based on a random results in response to game play instructions and determine any awards to be made to the player for the game outcomes; and
a sound controller adapted to select at least one sound from a set of a plurality of different sounds for reproduction by the audio output in response to a request to pay out an award to the player.

The system can comprise a data structure to store game data and a processor adapted to execute a set of executable instructions to implement a game controller process and a sound controller process.

The data structure can include data corresponding to each different sound of the set of a plurality of sounds, wherein, in response to a request for an award payout by a player, the processor executes a sound controller process comprising the steps of:
selecting a sound from the set;
generating a signal from the data corresponding to the selected sound; and
providing the generated signal to the audio output for reproduction of the selected sound.

The step of generating the signal from the data corresponding to the selected sound can include setting values of sound reproduction parameters based on the award. For example, sound reproduction parameters can include any one or more of duration, volume and pitch.

In an embodiment each of the plurality of sounds is based on an award value.

In another embodiment at least two of the plurality of sounds are associated with different coin denominations.

In an embodiment a sound is selected based on coins in the award.

In an alternative embodiment a sound is selected based on a denomination being played.

In another embodiment each sound, when reproduced, imitates the sound of one or more coins of the denomination hitting a metal tray.

In an embodiment of the gaming system the sound to be reproduced by the audio output when an award is paid out to a player is selected based on a unit bet amount wagered by the player in the game for which the award is paid.

The audio output can be a speaker.

According to another aspect there is provided a method of paying out an award for a game to a player playing the game using a player interface having an audio output, the method comprising the steps of:
receiving an instruction to pay out an award to the player;
selecting at least one sound from a set of a plurality of different sounds in response to an award pay out request;
paying out the award; and
reproducing each selected sound using the audio output.

In an embodiment the award is paid out by printing a credit ticket for redemption from a cashier.

In another embodiment the award is paid out by applying credit to a player's credit account.

According to another aspect there is provided a sound controller for a gaming system, the sound controller comprising:
a data structure including data corresponding to a set of a plurality of sounds;
processor adapted to execute a set of instructions to, in response to a request to pay out an award to a player, select at least one sound from the set, generate a signal from the data corresponding to the selected sound, and provide the generated signal to an audio output for reproduction of the selected sound.

In an embodiment of the sound controller generating the signal from the data corresponding to the selected sound includes setting values of sound reproduction parameters based on the award.

According to another aspect there is provided a computer program comprising computer readable instructions which, when executed, cause a computer to implement a method of paying out an award for a game to a player of the game using a player interface having an audio output, the method comprising the steps of:
receiving an instruction to pay out an award to the player;
selecting at least one sound from a set of a plurality of different sounds;
paying out the award; and
reproducing the selected sound using the player interface audio output.

### BRIEF DESCRIPTION OF SEVERAL VIEWS OF THE DRAWINGS

An exemplary embodiment of the invention will now be described with reference to the accompanying drawings in which:

FIG. 1 is a block diagram of the core components of a gaming system;

FIG. 2 is a perspective view of a stand alone gaming machine;

FIG. 3 is a block diagram of the functional components of a gaming machine;

FIG. 4 is a schematic diagram of the functional components of a memory;

FIG. 5 is a schematic diagram of a network gaming system;

FIG. 6 is a further block diagram of a gaming system; and

FIG. 7 is a flow chart of an embodiment.

### DETAILED DESCRIPTION OF THE INVENTION

Referring to the drawings, there is shown a gaming system having a game controller arranged to implement a game for which a player can win an award and on payout of the award a sound is played based on the award. For example, in a cashless game machine, the sound played when a payout ticket is printed may reproduce the sound of coins hitting a metal tray. Such a sound can cause excitement in a player and others nearby, as it replicates the sound of a traditional coin pay out, and increase their enjoyment of the game and gaming experience.

The gaming system can take a number of different forms. In a first form, a stand alone gaming machine is provided wherein all or most components required for implementing the game are present in a player operable gaming machine.

In a second form, a distributed architecture is provided wherein some of the components required for implementing the game are present in a player operable gaming machine and some of the components required for implementing the game are located remotely relative to the gaming machine. For example, a “thick client” architecture may be used wherein part of the game is executed on a player operable gaming machine and part of the game is executed remotely, such as by a gaming server; or a “thin client” architecture may be used wherein most of the game is executed remotely such as by a gaming server and a player operable gaming machine is used only to display audible and/or visible gaming information to the player and receive gaming inputs from the player.

However, it will be understood that other arrangements are envisaged. For example, an architecture may be provided wherein a gaming machine is networked to a gaming server and the respective functions of the gaming machine and the gaming server are selectively modifiable. For example, the gaming system may operate in stand alone gaming machine mode, “thick client” mode or “thin client” mode depending on the game being played, operating conditions, and so on. Other variations will be apparent to persons skilled in the art.

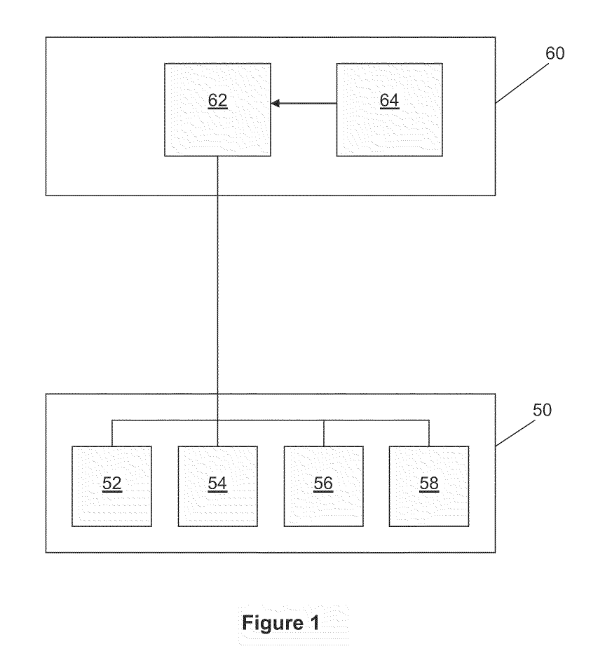

Irrespective of the form, the gaming system comprises several core components. At the broadest level, the core components are a player interface 50 and a game controller 60 as illustrated in FIG. 1. The player interface is arranged to enable manual interaction between a player and the gaming system and for this purpose includes the input/output components required for the player to enter instructions and play the game and observe the game outcomes.

Components of the player interface may vary from embodiment to embodiment but will typically include a credit mechanism 52 to enable a player to input credits and receive payouts, one or more displays 54, a game play mechanism 56 that enables a player to input game play instructions (e.g. to place a wager), and one or more speakers 58.

The game controller 60 is in data communication with the player interface and typically includes a processor 62 that processes the game play instructions in accordance with game play rules and outputs game play outcomes to the display. Typically, the game play instructions are stored as program code in a memory 64 but can also be hardwired. Herein the term “processor” is used to refer generically to any device that can process game play instructions in accordance with game play rules and may include: a microprocessor, microcontroller, programmable logic device or other computational device, a general purpose computer (e.g. a PC) or a server.

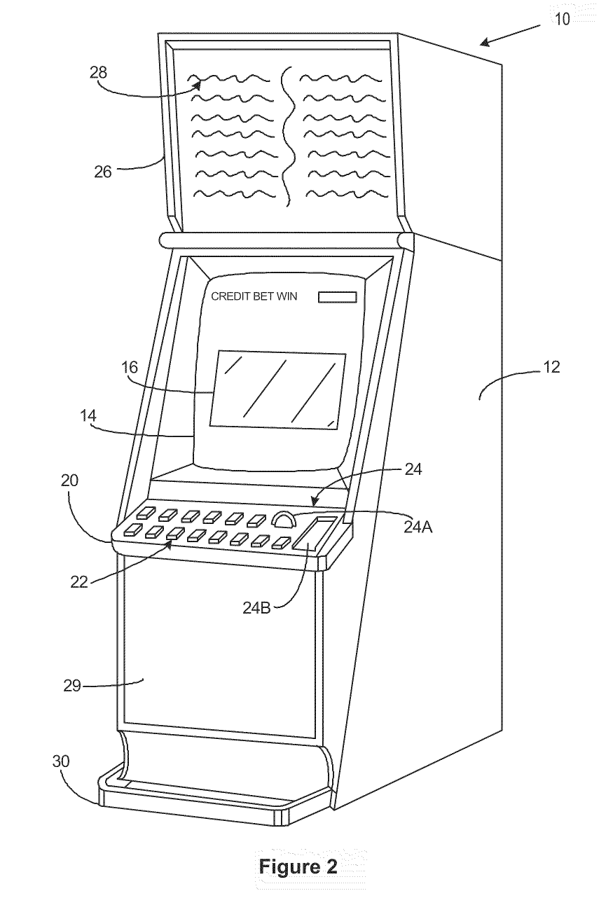

A gaming system in the form of a stand alone gaming machine 10 is illustrated in FIG. 2. The gaming machine 10 includes a console 12 having a display 14 on which are displayed representations of a game 16 that can be played by a player. A mid-trim 20 of the gaming machine 10 houses a bank of buttons 22 for enabling a player to interact with the gaming machine, in particular during game play. The mid-trim 20 also houses a credit input mechanism 24 which in this example includes a coin input chute 24A and a bill collector 24B. Other credit input mechanisms may also be employed, for example, a card reader for reading a smart card, debit card or credit card. A player marketing module (not shown) having a reading device may also be provided for the purpose of reading a player tracking device, for example as part of a loyalty program. The player tracking device may be in the form of a card, flash drive or any other portable storage medium capable of being read by the reading device.

A top box 26 may carry artwork 28, including for example pay tables and details of bonus awards and other information or images relating to the game. Further artwork and/or information may be provided on a front panel 29 of the console 12. A coin tray 30 is mounted beneath the front panel 29 for dispensing cash payouts from the gaming machine 10.

The display 14 shown in FIG. 2 is in the form of a video display unit, particularly a cathode ray tube screen device. Alternatively, the display 14 may be a liquid crystal display, plasma screen, any other suitable video display unit, or the visible portion of an electromechanical device. The top box 26 may also include a display, for example a video display unit, which may be of the same type as the display 14, or of a different type.

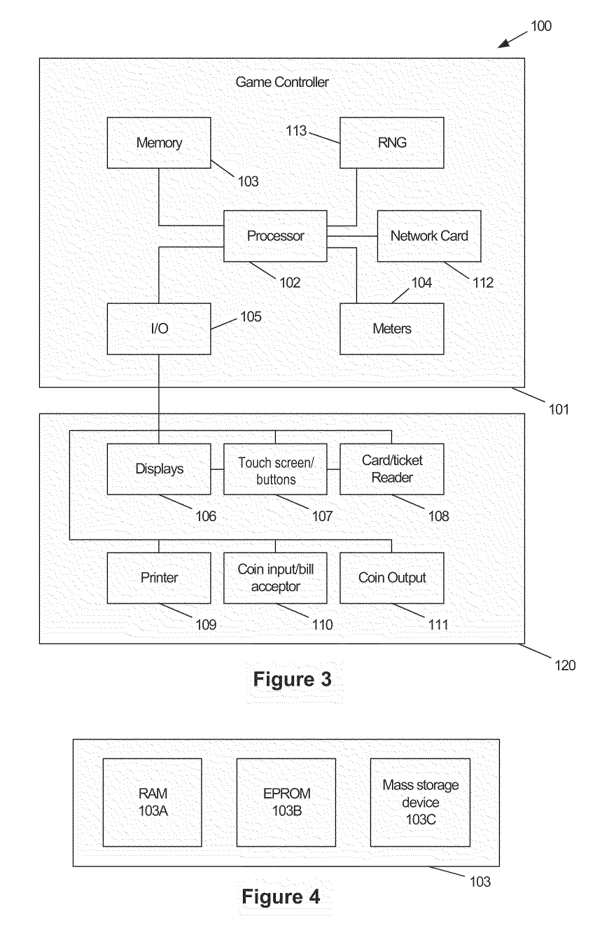

FIG. 3 shows a block diagram of operative components of a typical gaming machine which may be the same as or different to the gaming machine of FIG. 2.

The gaming machine 100 includes a game controller 101 having a processor 102. Instructions and data to control operation of the processor 102 are stored in a memory 103, which is in data communication with the processor 102. Typically, the gaming machine 100 will include both volatile and non-volatile memory and more than one of each type of memory, with such memories being collectively represented by the memory 103.

The gaming machine has hardware meters 104 for purposes including ensuring regulatory compliance and monitoring player credit, an input/output (I/O) interface 105 for communicating with peripheral devices of the gaming machine 100. The input/output interface 105 and/or the peripheral devices may be intelligent devices with their own memory for storing associated instructions and data for use with the input/output interface or the peripheral devices. A random number generator module 113 generates random numbers for use by the processor 102. Persons skilled in the art will appreciate that the reference to random numbers includes pseudo-random numbers.

In the example shown in FIG. 3, a player interface 120 includes peripheral devices that communicate with the game controller 101 comprise one or more displays 106, a touch screen and/or buttons 107, a card and/or ticket reader 108, a printer 109, a bill acceptor and/or coin input mechanism 110 and a coin output mechanism 111. Additional hardware may be included as part of the gaming machine 100, or hardware may be omitted as required for the specific implementation.

In addition, the gaming machine 100 may include a communications interface, for example a network card 112. The network card may, for example, send status information, accounting information or other information to a central controller, server or database and receive data or commands from the central controller, server or database.

FIG. 4 shows a block diagram of the main components of an exemplary memory 103. The memory 103 includes RAM 103A, EPROM 103B and a mass storage device 103C. The RAM 103A typically temporarily holds program files for execution by the processor 102 and related data. The EPROM 103B may be a boot ROM device and/or may contain some system or game related code. The mass storage device 103C is typically used to store game programs, the integrity of which may be verified and/or authenticated by the processor 102 using protected code from the EPROM 103B or elsewhere.

It is also possible for the operative components of the gaming machine 100 to be distributed, for example input/output devices 106,107,108,109,110,111 to be provided remotely from the game controller 101.

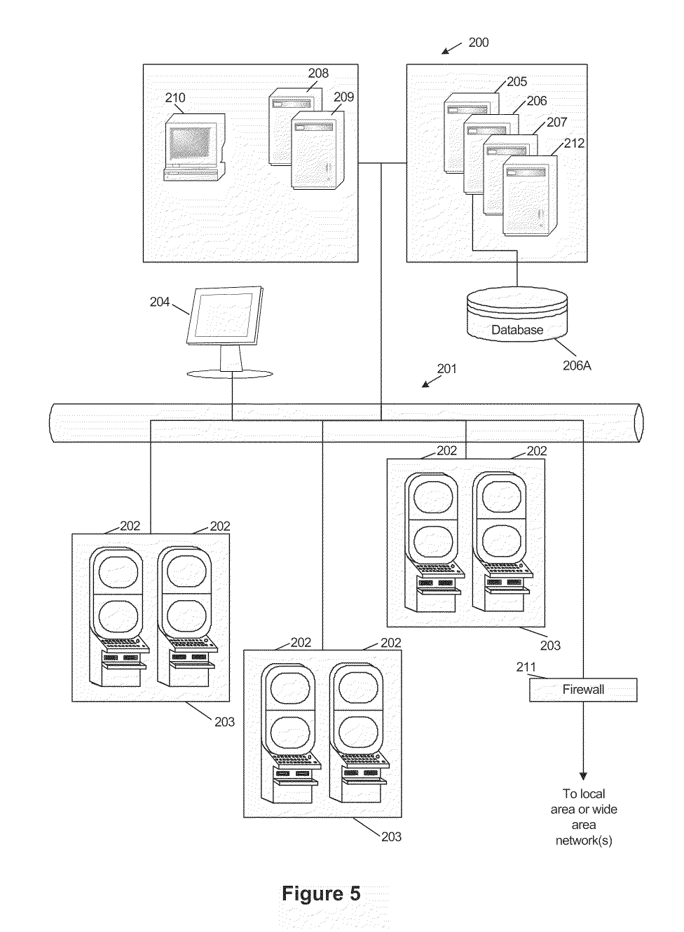

FIG. 5 shows a gaming system 200 in accordance with an alternative embodiment. The gaming system 200 includes a network 201, which for example may be an Ethernet network. Gaming machines 202, shown arranged in three banks 203 of two gaming machines 202 in FIG. 5, are connected to the network 201. The gaming machines 202 provide a player operable interface and may be the same as the gaming machines 10,100 shown in FIGS. 2 and 3, or may have simplified functionality depending on the requirements for implementing game play. While banks 203 of two gaming machines are illustrated in FIG. 5, banks of one, three or more gaming machines are also envisaged.

One or more displays 204 may also be connected to the network 201. For example, the displays 204 may be associated with one or more banks 203 of gaming machines. The displays 204 may be used to display representations associated with game play on the gaming machines 202, and/or used to display other representations, for example promotional or informational material.

In a thick client embodiment, game server 205 implements part of the game played by a player using a gaming machine 202 and the gaming machine 202 implements part of the game. With this embodiment, as both the game server and the gaming device implement part of the game, they collectively provide a game controller. A database management server 206 may manage storage of game programs and associated data for downloading or access by the gaming devices 202 in a database 206A. Typically, if the gaming system enables players to participate in a Jackpot game, a Jackpot server 207 will be provided to perform accounting functions for the Jackpot game. A loyalty program server 212 may also be provided.

In a thin client embodiment, game server 205 implements most or all of the game played by a player using a gaming machine 202 and the gaming machine 202 essentially provides only the player interface. With this embodiment, the game server 205 provides the game controller. The gaming machine will receive player instructions, pass these to the game server which will process them and return game play outcomes to the gaming machine for display. In a thin client embodiment, the gaming machines could be computer terminals, e.g. PCs running software that provides a player interface operable using standard computer input and output components. Other client/server configurations are possible, and further details of a client/server architecture can be found in WO 2006/052213 and PCT/SE2006/000559, the disclosures of which are incorporated herein by reference.

Servers are also typically provided to assist in the administration of the gaming network 200, including for example a gaming floor management server 208, and a licensing server 209 to monitor the use of licenses relating to particular games. An administrator terminal 210 is provided to allow an administrator to run the network 201 and the devices connected to the network.

The gaming system 200 may communicate with other gaming systems, other local networks, for example a corporate network, and/or a wide area network such as the Internet, for example through a firewall 211.

Persons skilled in the art will appreciate that in accordance with known techniques, functionality at the server side of the network may be distributed over a plurality of different computers. For example, elements may be run as a single “engine” on one server or a separate server may be provided. For example, the game server 205 could run a random generator engine. Alternatively, a separate random number generator server could be provided. Further, persons skilled in the art will appreciate that a plurality of game servers could be provided to run different games or a single game server may run a plurality of different games as required by the terminals.

Embodiments of the present gaming system are adapted to play a sound when an award is being paid out, the sound being selected based on the award. Increasingly casinos and gaming venues are using “cashless” gaming systems where players use a cards linked to a player account or tickets representing gaming credit rather than coins when placing bets and to receive payouts from various games. Such systems have advantages of ease of use by players and minimizing the amount of cash circulating on a gaming floor. However, some players enjoy the excitement of the sound of coins being paid out by a machine, and the ambience such sounds give to a gaming venue. Embodiments of the present system are particularly suited to such cashless gaming systems and can be adapted to reproduce the sounds of coins hitting a metal tray when a payout is made. Some embodiments are adapted to reproduce the sounds of different denominations of coins hitting a metal tray.

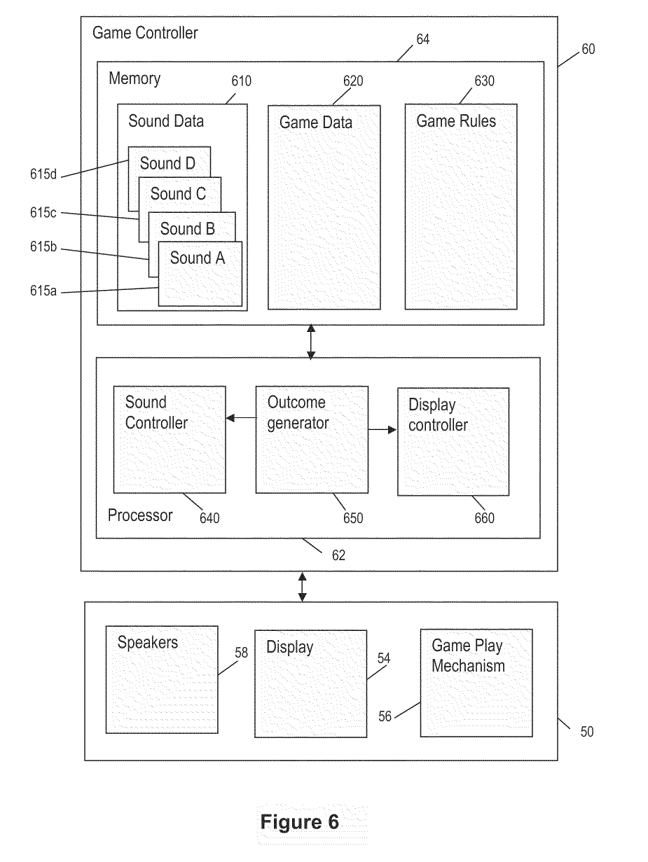

An embodiment of a gaming system adapted to reproduce different sounds based on an award payout is illustrated in FIG. 6. The system comprises a game controller 60 and a player interface 50. The player interface has a display 54, and game play mechanism 56 and one or more speakers 58. The game controller 60 has a memory 64 and processor 62. The processor 62 is adapted execute game play functions represented in FIG. 6 as an outcome generator 650, a display controller 660 and a sound controller 640. The memory 64 stores game data 620 and game rules 630 used for playing a game, for example by the outcome generator 650. The memory 64 of this embodiment also stores sound data 610 which includes data corresponding to a plurality of sounds 615a-d.

The sound controller is adapted to select one or the sounds 615a-d for reproduction by the player interface 50 speakers 58 when an award is paid out to the player. The sound 615a-d to be reproduced is selected based on the award. For example, the sound controller may be implemented as a set of instructions, such as a software program or script, executable by the processor 62. The sounds 615a-d may be pre-recorded sound samples (for example .wav or MP3 sound files) or data used for synthesizing sounds (for example MIDI files) stored as sound data 610 in memory 64. The sound controller can include instructions for selecting a sound 615a-d based on the award, and instructions for generating a sound signal for reproduction of the sound by an audio output. Generating a sound signal may include some manipulation of the sound data file or synthesizing of the sound, depending on the embodiment implemented. In alternative embodiments the sound controller may be implemented as a combination of two or more of software, firmware and hardware.

The outcome generator 650 operates in response to the player's operation of game play mechanism 56 to generate a game outcome which will then be evaluated and any award payable for the outcome recorded for the player, for example using win meter. Embodiments can be used with any type of game, for example spinning reel games, card dealing games, dice games etc using either software or hardware based random result generation processes in forming game outcomes. For example, the first part of forming the game outcome is for a symbol selector to select symbols from a set of symbols specified by symbol data. The selected symbols are advised to the display controller 660 which causes them to be displayed on display 54 at a set of display positions.

One example of selecting symbols is for the symbol selector to select symbols for display from a plurality of symbol sets corresponding to respective ones of a plurality of spinning reels. The symbol sets can specify a sequence of symbols for each reel such that the symbol selector can select a symbol by selecting a stopping position in the sequence. In one example, three symbols of each of five reels may be displayed such that symbols are displayed at fifteen display positions on display 54. An outcome can then be determined based on combinations of symbols positioned along win lines wagered on by the player.

The amount to be awarded to the player for a winning combination can be based on the combination and the wager amount. The awarded amount, for example a given number of credits can then be added to a player's cumulative credit total. Once the play of a game is completed, the player can choose to play a further game using some of the cumulative credit total for wagering in the new game play.

Alternatively the player can choose to have some or all of the cumulative credit value paid out. For example, a player interface may be provided with a ticket printer and awards are paid out to a player by printing a payout ticket redeemable for cash from a cashier. Embodiments of the present system are adapted to cause a sound to be played when an award is paid out. The sound is selected, based on the award, from a set of sounds.

For example the set of sounds may be a plurality of tunes. Selection criteria can be assigned for each tune such as an award value range for which each tune applies. When a player elects to have an award paid out the sound controller 640 can compare the value of the award with the assigned value ranges and select the sound for which the award value falls within the assigned value range. Once the sound is selected a signal is generated from data corresponding to the selected sound and provided to the player terminal 50 for reproduction of the selected sound using the speaker 58.

It should be appreciated that sound data 610 may comprise a plurality of sound data files 615a-d. Each sound data file includes sound reproduction data. The sound reproduction data may include recorded sound data, for example sound data recorded, encoded, and stored in a digital format such as MP3 or WAVE files. In this embodiment the player interface may be provided with a compatible player for decoding and reproduction the recorded sound. Alternatively the sound reproduction data may comprise data from which a sound can be synthesized. In this embodiment a player interface may be adapted to synthesize sounds based on the sound reproduction data, for example a MIDI file.

The sound controller may also be adapted to control sound reproduction parameters such as repetition, duration, volume and pitch for playing the sound. For example, in one embodiment for a sound the sound reproduction data is a recording of a one dollar coin hitting a metal tray and the reproduction parameters are the number of repetitions and volume. For a player being paid out twenty dollars, the sound controller may set the repetition parameter value to twenty and the volume parameter value to a mid level of five, whereas for a player being paid out one hundred dollars the repetition parameter value may be one hundred and the volume increased to a higher level of seven. In an embodiment where a sound is a tune the pitch parameter value may be incremented for each one hundred credits paid out which corresponds to the tune being played a semi tone higher for each hundred credits. In another example the sound reproduction data is a three minute long recording of a cascade of twenty cent coins falling into a metal tray stored as an MP3 file and the duration parameter can be set such that the file is played for a specified time, such as thirty seconds or one minute, based on the award amount being paid out. Alternatively a fifteen second recording of a cascade of one dollar coins may be played in part, in full or repeated one or more times based on the award amount being paid out.

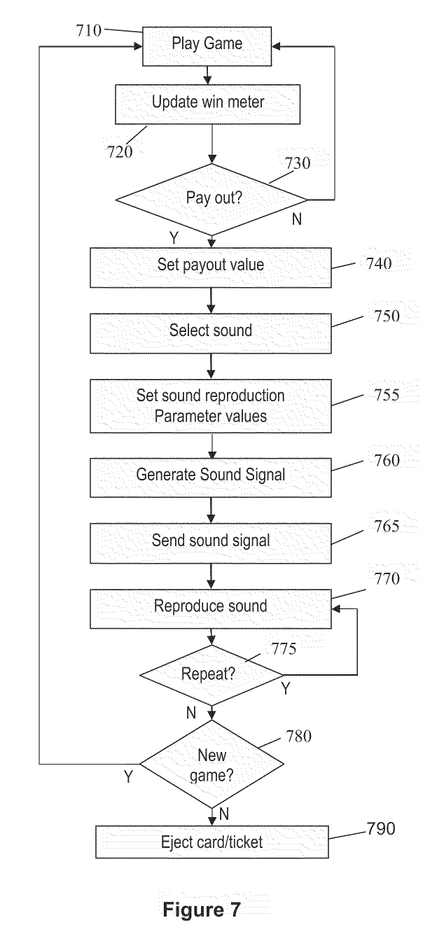

FIG. 7 illustrates an embodiment of a process for paying out an award for a game. A player plays a game 710 for which a winning game outcome occurs. For example, a number of credits may be won for the game outcome. The credits won are added to a cumulative win total or win meter 720 being maintained for the player for the game. At the end of the game play the player has the option 730 to continue playing or pay out all or part of the credit total won.

Where the player chooses to pay out all their winnings, for example where they wish to stop playing or move to another player terminal, the award to be paid out is set 740 to the total value of the win meter. Where the player chooses to pay out only a portion of their win total the player can use an input mechanism of the player interface to designate the amount to be paid out, for example where they have a win total of two thousand credits, the player may choose to pay out one thousand credits and continue playing with the remaining one thousand credits. The award to be paid out is then set 740 to the value designated by the player.

Once a payout value is set 740 a sound to be played is selected 750 based on the award from a plurality of available sounds. Optionally sound reproduction parameter values can also be set 755 to control aspects of sound reproduction such as duration, volume, pitch and repetition. For example, based on the payout value total a sound controller may access a lookup table and select a sound associated with a value range. Alternatively, a sound may be selected based on credit units bet in the game, for example five credits per win line, and sound reproduction parameters set based on the number of credits to be paid out. In each of these alternative examples the sound reproduced is based on the award being paid out.

A sound signal is then generated 760 and sent to the player interface 765 for reproduction 770 of the sound by an audio output of the player interface. In the embodiment illustrated if the sound is to be repeated 775, for example, where the sound is a coin falling a repetition parameter value may indicate the sound is to be repeated five times, the player interface will repeat play of the sound for the specified number of times. In an alternative embodiment a signal may be sent to the player interface for each repetition.

The step of generating the sound signal 760 may include synthesizing the sound based on sound data, such as a MIDI file and sound parameter values. For example, sound parameters may indicate duration, based on the ward amount, and a pitch based on the denomination wagered, which are used in combination with the MIDI data to synthesize a sound signal which can then be sent to the player interface for reproduction by the speakers.

Once the sound is played and the payout is made it is determined whether a new game is to be played 780. If the payout was a partial payout a new game 780 is to be played, otherwise the player's card or ticket can be ejected 790 and the player move on to play another machine or redeem their credit from a cashier.

The actual pay out can be synchronized with the sound being played. For example, setting a payout value causes a payout mechanism to be activated to pay out the award. In an embodiment where an award amount is transferred to a player account, credit card or smart card the payout may be made immediately. However, in an embodiment where a payout ticket printed by a credit mechanism of a player interface, printing of the payout ticket and playing the sound may occur simultaneously. In this embodiment the payout mechanism may be synchronized with a sound controller to make the payment at the same time a sound is played. Alternatively the sound signal may also be used to trigger the payout mechanism to print out the ticket. Alternatively extracting the printed ticket from the payout mechanism may cause the sound to be played.

It should be appreciated that in a thin client or stand along gaming machine embodiment the sound controller may be adapted to perform functions such as decoding a sound file or synthesizing a sound from sound data and provide a signal to drive the speaker of the player interface to reproduce the selected sound. In an alternative networked gaming system thick client embodiment the player interfaces can have a sound synthesizing capability or have sound data files stored in payer interface memory to be used for reproducing sounds in response to a sound selection signal received from a sound controller via the network. In this embodiment the sound selection signal can include a sound identifier used to select the sound file form player interface memory and sound reproduction parameter values such as repetition, duration, volume and pitch.

In an alternative embodiment the player interface may be adapted to synthesize the sound signal for reproduction using the speakers based on MIDI data provided to the player interface by the sound controller. In this embodiment the sound controller can generate a MIDI file based on the MID file stored in sound data and the sound parameters which is then transmitted to the player interface. A synthesizer of the player interface then synthesizes the sound based on the MIDI file and plays the sound using the speakers.

It will be appreciated by a person skilled in the art that the selection criteria for a sound and sound parameter values can be based on a variety of player actions or game outcomes as well as characteristics of the award to be paid out.

Embodiments of the present system can use player win entitlement, wager amounts or other game data in addition to the payout award value to select the sound to be played when the award is paid out. For example, a sound representing a coin denomination may be selected based on a symbol, say a one dollar symbol, which occurred during a preceding spinning reel game. In this example the player may have a credit of one hundred dollars to be paid out and the sound played when the award is paid mimics the sound of one dollar coins falling onto a metal tray. If the dollar symbol did not appear in a spinning reel game the sound played may mimic the sound of five cent coins falling on a metal tray. It should be appreciated that the different pitch of the sound of dollar coins compared to five cent coins can be distinguished by the player and other people in the vicinity of the player terminal and add to the entertainment and atmosphere of the gaming venue. Such sounds can cause excitement in a player and others near by, as it replicates the sound of a traditional coin paid out, and increase their enjoyment of the game and gaming experience in a system using cashless gaming machines.

Alternative embodiments may be used in cash dispensing game machines and the sounds used may alter depending on the embodiment. For example, a cash dispensing game machine which issues notes may use coin sounds of different denominations. However, a coin dispensing machine may have a menu of different tunes to play based on the award, so a player will have the excitement of a coin payout as well as a tune celebrating their award being played. Alternatively celebratory sounds, such as samples of animal sounds may be played, for example the roar of a lion or trumpet of an elephant depending on the award. The sounds played when awards are paid out may also be associated with a game theme. In some embodiments alternative audio outputs may be provided in addition to speakers or as an alternative to speakers. Some example of alternative audio outputs include bells, whistles, sirens, horns, hooters, clappers, pipes etc. These may be activated in response to a sound signal to output their respective sounds when a payout is made to for the player's entertainment.

It will be understood to persons skilled in the art of the invention that many modifications may be made without departing from the spirit and scope of the invention, in particular it will be apparent that certain features of the invention can be combined to form further embodiments.

It is to be understood that, if any prior art publication is referred to herein, such reference does not constitute an admission that the publication forms a part of the common general knowledge in the art, in Australia or any other country.

In the claims which follow and in the preceding description of the invention, except where the context requires otherwise due to express language or necessary implication, the word “comprise” or variations such as “comprises” or “comprising” is used in an inclusive sense, i.e. to specify the presence of the stated features but not to preclude the presence or addition of further features in various embodiments of the invention.

1. A gaming system comprising:
a player interface including an input mechanism for entering game play instructions, a display for displaying game outcome information and an audio output;
a game controller adapted to generate game outcomes for a player based on a random results in response to game play instructions and determine any awards to be made to the player for the game outcomes; and
a sound controller adapted to select at least one sound from a set of a plurality of different sounds for reproduction by the audio output in response to a request to pay out an award to the player.

2. A gaming system as claimed in claim 1 wherein the system comprises a data structure to store game data and a processor adapted to execute a set of executable instructions to implement a game controller process and a sound controller process.

3. A gaming system as claimed in claim 2 wherein the data structure includes data corresponding to each different sound of the set of a plurality of sounds, wherein, in response to a request for an award payout by a player, the processor executes a sound controller process comprising the steps of:
selecting a sound from the set;
generating a signal from the data corresponding to the selected sound; and
providing the generated signal to the audio output for reproduction of the selected sound.

4. A gaming system as claimed in claim 3 wherein the step of generating the signal from the data corresponding to the selected sound includes setting values of sound reproduction parameters based on the award.

5. A gaming system as claimed in claim 4 wherein sound reproduction parameters include any one or more of duration, volume and pitch.

6. A gaming system as claimed in claim 1 wherein each of the plurality of sounds is based on an award value.

7. A gaming system as claimed in claim 1 wherein at least two of the plurality of sounds are associated with different coin denominations.

8. A gaming system as claimed in claim 7 wherein a sound is selected based on coins in the award.

9. A gaming system as claimed in claim 7 wherein a sound is selected based on a denomination being played.

10. A gaming system as claimed in claim 7 wherein each sound, when reproduced, imitates the sound of one or more coins of the denomination hitting a metal tray.

11. A gaming system as claimed in claim 10 wherein the sound to be reproduced by the audio output when an award is paid out to a player is selected based on a unit bet amount wagered by the player in the game for which the award is paid.

12. A gaming system as claimed in claim 1 wherein the audio output is a speaker.

13. A method of paying out an award for a game to a player playing the game using a player interface having an audio output, the method comprising the steps of:
receiving an instruction to pay out an award to the player;
selecting at least one sound from a set of a plurality of different sounds in response to an award pay out request;
paying out the award; and
reproducing each selected sound using the audio output.

14. A method as claimed in claim 13, wherein the award is paid out by printing a credit ticket for redemption from a cashier.

15. A method as claimed in claim 13, wherein the award is paid out by applying credit to a player's credit account.

16. A method as claimed in claim 13, wherein a data structure stores data corresponding to the set of sounds and the method further comprises the steps of:
generating a signal from the data corresponding to a selected sound; and
providing the generated signal to the audio output for reproduction of the selected sound.

17. A method as claimed in claim 16, wherein the step of generating the signal from the data corresponding to a selected sound includes setting values of sound reproduction parameters based on the award.

18. A method as claimed in claim 17, wherein sound reproduction parameters include any one or more of duration, volume and pitch.

19. A method as claimed in claim 13 wherein each of the plurality of sounds is based on an award value.

20. A method as claimed in claim 13 wherein at least two of the plurality of sounds are associated with different coin denominations.

21. A method as claimed in claim 20 wherein a sound is selected based on coins in the award.

22. A method as claimed in claim 20 wherein a sound is selected based on a denomination being played.

23. A method as claimed in claim 20 wherein each sound, when reproduced, imitates the sound of one or more coins of the denomination hitting a metal tray.

24. A method as claimed in claim 23 wherein the sound to be reproduced by the audio output when an award is paid out to a player is selected based on a unit bet amount wagered by the player in the game for which the award is paid.

25. A sound controller for a gaming system, the sound controller comprising:
data structure including data corresponding to a set of a plurality of sounds;
processor adapted to execute a set of instructions to, in response to a request to pay out an award to a player, select at least one sound from the set, generate a signal from the data corresponding to the selected sound, and provide the generated signal to an audio output for reproduction of the selected sound.

26. A sound controller as claimed in claim 25 wherein generating the signal from the data corresponding to the selected sound includes setting values of sound reproduction parameters based on the award.

27. A computer program comprising computer readable instructions which, when executed, cause a computer to implement a method of paying out an award for a game to a player of the game using a player interface having an audio output, the method comprising the steps of:
receiving an instruction to pay out an award to the player;
selecting at least one sound from a set of a plurality of different sounds;
paying out the award; and
reproducing the selected sound using the player interface audio output.
